(19) United States
(12) Patent Application Publication
(10) Pub. No.: US 2021/0146520 A1
(43) Pub. Date: May 20, 2021

(54) PISTON

(71) Applicant: Black & Decker Inc., New Britain, CT (US)

(72) Inventors: Tobias HEEP, Steinbach (DE); Achim BUCHHOLZ, Limburg (DE); Jozef BRISSAK, Oravske Vesele (SK)

(21) Appl. No.: 17/097,041

(22) Filed: Nov. 13, 2020

(30) Foreign Application Priority Data
Nov. 15, 2019 (GB) 1916665.1

(51) Int. Cl. B25D 17/06; B25D 17/26; B25D 16/00

(52) U.S. Cl. CPC B25D 17/06; B25D 17/26; B25D 16/006; B25D 2217/0096; B25D 2217/0023; B25D 2250/095; B25D 2250/191; B25D 2216/0084

(57) ABSTRACT

A piston for a hammer drill is a flat piston made from sintered steel. The piston can be impregnated with a lubricant.

### CROSS-REFERENCE TO RELATED APPLICATIONS

This application claims priority, under 35 U.S.C. § 119, to UK Patent Application No. 1916665.1 filed Nov. 15, 2019.

### FIELD

The present invention relates to a piston for a hammer drill.

### BACKGROUND

A typical hammer drill comprises a body in which is mounted an electric motor and a hammer mechanism. A tool holder is mounted on the front of the body which holds a cutting tool, such as a drill bit or a chisel. The hammer mechanism typically comprises a ram, slidably mounted in a cylinder, reciprocatingly driven by a piston via an air spring, the piston being reciprocatingly driven by the motor via a set of gears and a crank mechanism or wobble bearing. The ram in turn repeatedly strikes the end of the cutting tool via a beat piece. When the only action on the tool bit is the repetitive striking of its end by the beat piece, the hammer drill is operating in a hammer only mode.

Certain types of hammer drill also comprise a rotary drive mechanism which enables the tool holder to rotatingly drive the cutting tool held within the tool holder. In such constructions, the cylinder is the form of a rotatable spindle. This can be in addition to the repetitive striking of the end of the cutting tool by the beat piece (in which case, the hammer drill is operating in a hammer and drill mode) or as an alternative to the repetitive striking of the end of the cutting tool by the beat piece by switching off the hammer mechanism (in which case, the hammer drill is operating in a drill only mode).

EP1157788 discloses such a hammer drill.

Hammer drills typically use one of two types of piston.

The first type of piston is known as a flat piston. A flat piston locates inside of a cylinder or spindle. The ram also mounts directly in the spindle or cylinder directly in front of the flat piston. The air spring formed between the ram and piston is contained within a chamber formed by the front end of the piston, the inner side walls of the spindle or cylinder and the rear of the ram. A flat piston makes has no direct contact with the ram. DE4202767 discloses a hammer drill with a flat piston.

The second type of piston is known as a hollow piston. A hollow piston locates inside of a cylinder or spindle. A tubular recess is formed inside of the front of the hollow piston. The ram mounts directly in the recess of the hollow piston. The air spring formed between the ram and piston is contained within the recess and is formed within a chamber formed by inner walls of the recess of the hollow piston and the rear of the ram. A hollow piston is in direct contact with and provides support for the ram. The ram makes no contact with the spindle or cylinder. EP1157788 discloses a hammer drill with a hollow piston.

Pistons used in hammer drills are typically constructed from aluminum or plastic.

A prior art design of hammer mechanism will new de described with reference to FIGS. 1 to 5.

Referring to FIG. 1, a hammer drill comprises a body 2 having a rear handle 4 moveably mounted to the rear of the body 2. The rear handle 4 comprises a centre grip section 90 and two end connection sections 92; 94, one end connection section being attached to one end of the centre grip section, the other end connection section being connected to the other end of the centre grip section. The handle 4 is connected to the rear of the body 2 by the two end connection sections 92, 94. The rear handle is constructed from a plastic clam shell 100 and a rear end cap 102 which is attached to the clam shell 100 using screws (not shown). The rear of the body is formed by three plastic clam shells 6, 70, 72 which attach to each other and to the remainder of the body 2 using screws (not shown).

An SDS tool holder 8 is mounted onto the front 10 of the body 2. The tool holder can hold a cutting tool 12, such as a drill bit. A motor (shown generally by dashed lines 48) is mounted within the body 2 which is powered by a mains electricity supply via a cable 14. A trigger switch 16 is mounted on the rear handle 4. Depression of the trigger switch 16 activates the motor in the normal manner. The motor drives a hammer mechanism (shown generally by dashed lines 46 in FIG. 1), which comprises a flat piston 204 reciprocatingly driven by the motor via a crank shaft 206 within a spindle 150, which in turn reciprocatingly drives a ram 152 via an air spring 170 which in turn strikes, via a beat piece 156, the end of the cutting tool 12. The motor can rotationally drive the spindle 150 via a bevel gear 200 and torque clutch 202. A mode change mechanism (not shown) can switch the hammer drill between three modes of operation, namely hammer only mode, drill only mode or hammer and drill mode. A rotatable knob 18 is mounted on the top of the body 2. Rotation of the knob 18 changes the mode of operation of the hammer drill in a well-known manner.

Referring to the FIG. 2, the spindle 150 has a longitudinal axis 154. Inside of the spindle 150 is located the ram 152, forward of the flat piston 204, a beat piece 156, forward of the ram 152, a ram catcher located between the ram 152 and the beat piece 156 and a beat piece support structure.

The forward end 162 of the spindle 150 forms part of the tool holder 8. During normal use, the cutting tool 12 (shown in dashed lines in FIG. 2) is held within the forward end 162 of the spindle 50 by the tool holder. The cutting tool 12 is prevented from rotating relative to the spindle 50 whilst being capable of moving axially over a limited range of movement within the forward end 162 of the spindle 150 in well-known manner.

The flat piston 204 is mounted directly in the rear of the spindle 150 and comprises an O ring 208 which locates in a groove formed around the main body of the flat piston and which provides an airtight seal between the flat piston and the inner wall of the spindle 150.

The ram 152 is mounted directly in the spindle 150 and comprises a main body 166 attached to an end cap 160, via a neck 168, of smaller diameter than the main body 166 of the ram 152, located at the forward end of the ram 152. The ram is circular in cross section in any plane which extends perpendicularly from the longitudinal axis 154 (which is co-axial with the longitudinal axis of the spindle 150 when the ram is located inside of the spindle) of the ram 152 along its length. The ram 152 comprises an O ring 158 which locates in a groove formed around the main body 166 of the ram and which provides an airtight seal between the ram 152 and the inner wall of the spindle 150. During normal operation of the hammer, the ram 152 is reciprocatingly driven by the flat piston 204 via an air spring 170 formed between the flat piston 204 and ram 152 in a well-known manner along the longitudinal axis 154. The air spring 170 between the ram 152 and the flat piston 204 is maintained by the air in the air spring 170 being prevented from escaping from (or air external of the air spring entering into) the space between the flat piston 204 and ram 152 due to the two O rings 208, 158.

The ram catcher comprises a rubber ring 214 which locates against the inner wall of the spindle 150 and is axially held in position inside of the spindle by being sandwiched between a ring retainer, comprising a circlip 216 and metal washer 218, and a metal tubular insert 210 of the beat piece support structure, both being located inside of the spindle 150. The rubber ring 214 provides a lip which projects radially inwardly into spindle 150 towards the longitudinal axis 154. The diameter of the aperture formed by the rubber ring 214 is less than that of the end cap 160 of the ram 152 but similar to that of the neck 168 of the ram 152. A series of holes 220 are formed around the circumference of the spindle rearward of the circlip 216 which each extend through the wall of the spindle 150.

During the normal operation of the hammer drill, when the cutting tool is engaged with a work piece, the ram 152 is reciprocatingly driven over a range of axial positions (one of which is shown in FIG. 2) inside of the spindle located to the rear of the ram catcher, the ram 152 being prevented from engaging the ram catcher due to the position of the beat piece 156. The ring 214 has no contact with any part of the ram 152 during the normal operation of the tool. When the ram 152 is able to move forward, due to the position of the beat piece, the end cap 160 engages with the rubber ring 214 and passes through the aperture due to the ring deforming, allowing the lip to flex to enable the cap 160 to pass through it. Once the cap 160 has passed through the ring 214, the lip returns to its original shape, locating in the neck 168 of the ram to hold the ram 152 stationary (as shown in FIGS. 3 and 4).

The beat piece 156 is supported by a beat piece support structure formed in part by the spindle 150 and in part by a support structure inside the spindle 150 comprising a metal tubular insert 210 sandwiched between an O ring 212 and the rubber ring 214 of the ram catcher. The beat piece 156 is circular in cross section in any plane which extends perpendicularly from the longitudinal axis 154 (which is co-axial with the longitudinal axis of the spindle 150 when the beat piece is located inside of the spindle) of the beat piece 156 along its length, the centre of the circular cross section being located on the longitudinal axis.

The beat piece 156 comprises a middle section 172, a front section 174 and a rear section 176.

The middle section 172 has a uniform diametered circular cross section along its length, the centre of the circular cross section being located on the longitudinal axis 154.

The rear section 176 has a uniform diametered circular cross section along its length, the centre of the circular cross section being located on the longitudinal axis 154. The rear end 240 of the rear section 176 is flat and is impacted by the cap 160 of the ram 152 during normal operation. The rear section 176 is joined to the middle section 172 via a first angled region 242. The first angled region 242 engages with a correspondingly shaped first angled shoulder 244 formed on the metal insert 210 located inside the spindle when the beat piece is in its most rearward position, limiting the amount of rearward movement of the beat piece 156. The wall of the angled shoulder 244 is circular in cross section in any plane which extends perpendicularly from the longitudinal axis 154 of the spindle 150, the centre of the circular cross section being located on the longitudinal axis. When the first angled region 242 is in engagement with the first angled shoulder 244, there is a uniform amount of contact between the two surfaces around the longitudinal axis 154.

The front section 174 is frustoconical in shape centered around the longitudinal axis 154 of the beat piece 156. The front end 246 of the front section 174 is flat and impacts the cutting tool 12 during normal operation. The front section 174 is joined to the middle section 172 via a second angled region 248 which is frustoconical in shape centered around the longitudinal axis 154 of the beat piece 156. The second angled region 248 engages with a correspondingly shaped second angled shoulder 250 formed on the inner wall of the spindle 150 when the beat piece is in its most forward position, limiting the amount of forward movement of the beat piece 156. The wall of the second angled shoulder 250 is circular in cross section in any plane which extends perpendicularly from the longitudinal axis 154 of the spindle 150, the centre of the circular cross section being located on the longitudinal axis 154. When the second angled region 248 is in engagement with the second angled shoulder 250, there is a uniform amount of contact between the two surfaces around the longitudinal axis 154.

When the hammer drill is operating in the normal manner with the cutting tool 12 cutting a work piece, the ram strikes the beat piece 156 which in turn strikes the end of cutting tool 12 in the tool holder 8. The ram 152 is reciprocatingly driven over a limited range of axial movement within the spindle, the maximum distance from the flat piston being limited by the position of the beat piece 156 which it impacts, the position of which in turn is controlled by the end of the cutting tool 12. Whilst traveling within this range of axial movement, the O ring 158 of the ram 152 does not pass the holes 220. As such, the air spring 170 between the flat piston 204 and ram 152 is maintained. The rear section 176 projects rearwardly through the aperture of the ring 214 of the ram catcher, to enable the cap 160 of the ram 152 to strike it as shown in FIG. 2.

When the cutting tool 12 is removed from the work piece, the beat piece 156 is able to move forward as the cutting tool 12 can extend out of the tool holder 8 to its maximum position. If the motor is still running, the flat piston 204 is able to drive the ram 152 via the air spring 170 further along the spindle 150, as the beat piece 156 can move forward, passing the air holes 220. Once the O ring 158 of the ram 152 has passed the air holes 220, the air is able to freely pass into and out of the spindle 150 in the space between the flat piston 204 and ram 152, causing the air spring 170 to be broken and thus disconnecting the drive between the flat piston 204 and ram 152. As the air spring 170 is broken, the ram 152 is able freely continue to travel along the length of the spindle 150. The ram 152 engages with the ram catcher, the cap 160 passing through the ring 214 allowing the neck 168 to engage with the ring, to secure the ram in the ram catcher, as seen in FIGS. 3 and 4. The reciprocating movement of the flat piston 204 has no effect on the ram 152 as the air spring 170 is broken due to the holes 220 which allow air in and out of the spindle 170 in the space between the flat piston 204 and ram 152. The beat piece 156 is pushed forward in the spindle 150 by the ram 152 in the ram catcher. In order to release the ram 152 from the ram catcher, the cutting tool 12 is pressed against a work piece causing it to be pushed into the tool holder 8, which in turn pushes the beat piece 156 rearwardly into engagement with the cap 160 of the ram 152, pushing it out of the ram catcher and past the holes 220. In such a position, the air spring 170 is reformed and the flat piston 204 is able to reciprocatingly drive the ram 152 again.

### SUMMARY

According to an embodiment, there is provided a piston for a hammer drill characterized in that the piston is a flat piston made from sintered steel.

The used of sintered steel to manufacture a piston enables the density of the steel in the piston to be controlled which in turn allows for the weight of the piston to be adjusted and optimised. Optimizing the weight of the piston is important as it effects the forces experienced by the reciprocating drive mechanism for the piston as it reciprocatingly drives the piston within the cylinder. This in turn effects the amount of vibration generated by the hammer mechanism.

The piston may be impregnated with a lubricant. The lubricant can be oil.

The advantage of using sintered steel for a piston is that it is porous. The porosity of the sintered steel piston allows lubricants to flow through the piston and/or remain captured within the piston.

The captured oil within the piston improves the lubrication of the piston within the cylinder by reducing the frictional contact between the piston and cylinder which in turn provides a smoother movement of the piston within the cylinder. This reduces heat and vibration generated by the movement of the piston within the cylinder.

A problem associated with the reciprocating movement of a piston in a cylinder is that hot spots in the piston are generated by the friction between the outer surface of the piston and the inner wall of the cylinder as the piston is reciprocatingly driven in the cylinder. A hot spot is where a particular part of the piston increases in temperature when compared to other parts of the piston. The flow of the lubricant through the piston allows the heat in the hot spot to be transferred with the flowing lubricant to other parts of the piston, thus cooling the hot spot and creating a piston with a more unified temperature across all parts of the piston.

It will be appreciated by the skilled person that addition grease can be applied to the surface of the piston and/or inner wall of the cylinder to further improve lubrication.

The piston may comprise a front circular disk having flat front surface; a circumferential groove extending around the edge of the circular disk; a circular peripheral wall extending rearwardly from the edge of the circular disk, perpendicularly to the plane of the circular disk; two straight sections formed on two opposite sides of the wall; a frame formed on each straight section; and an aperture formed through each frame and straight section.

A hammer drill which may use such a piston can comprise a housing, a tool holder mounted on the housing which is capable of holding a cutting tool, a motor mounted within the housing, and a hammer mechanism. The hammer mechanism includes a cylinder, a piston mounted in the cylinder that is reciprocatingly driven along a longitudinal axis by the motor when the motor is actuated, a ram mounted in the cylinder forward of the piston that is reciprocatingly driven on the longitudinal axis by the reciprocating piston via an air spring, and a beat piece supported in an axially slideable manner on the longitudinal axis within a beat piece support structure which, during the normal operation of the hammer mechanism, is repetitively struck by the ram and which transfers the impacts to a cutting tool when held by the tool holder.

Ideally, the cylinder is made from steel. The advantage of manufacturing the cylinder from steel is that the cylinder will have the same coefficient of expansion as the sintered steel piston. As such, the piston and cylinder will expand at the same rate as the temperature in the piston and cylinder increases. Therefore, the lubrication gap between the inner wall of the cylinder and outer wall of the piston will remain the same independently of the temperature of the piston and cylinder. As such, the size of gap can be optimized for lubrication across all working temperatures.

The cylinder may be formed as part of a spindle.

In an embodiment, the cylinder is made from sintered steel. Such a cylinder can be impregnated with a lubricant such as oil.

### BRIEF DESCRIPTION OF THE DRAWINGS

The drawings described herein are for illustrative purposes only of selected embodiments and not all possible implementations and are not intended to limit the scope of the present disclosure.

FIG. 1 shows a side view of a prior art hammer drill;

FIG. 2 shows a cross sectional view of the hammer mechanism with the ram in a position where it can freely slide within the spindle;

FIG. 3 shows a cross sectional view of the hammer mechanism with the ram in the ram catcher and the beat piece sliding in the spindle;

FIG. 4 shows a cross sectional view of the hammer mechanism with the ram in the ram catcher and the beat piece in its furthest forward position in the spindle;

FIG. 5 shows the beat piece;

FIG. 6 shows a vertical cross-sectional view of a hammer drill in accordance with the present invention;

FIG. 7 shows a rear view of the piston shown in FIG. 6;

FIG. 8 shows a side view of the piston shown in FIG. 6;

FIG. 9 shows a rear perspective view of the piston shown in FIG. 6; and

FIG. 10 shows a front perspective view of the piston shown in FIG. 6.

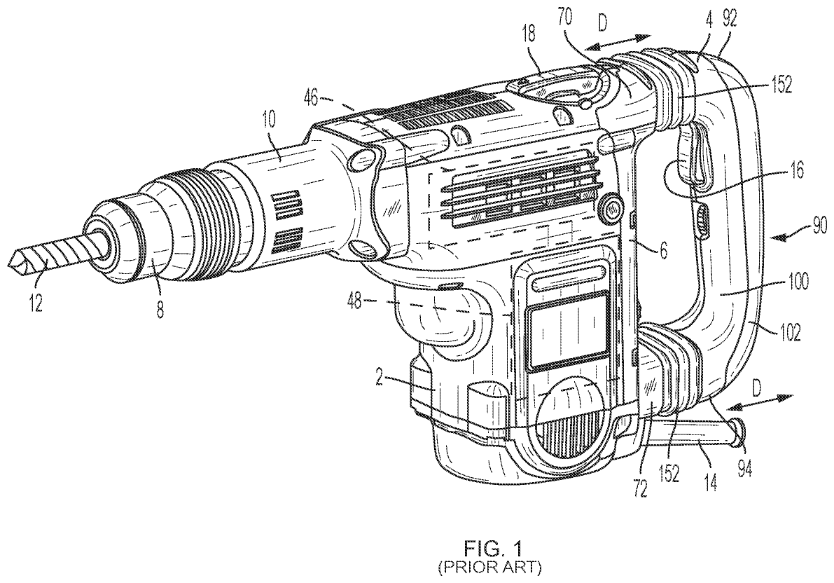

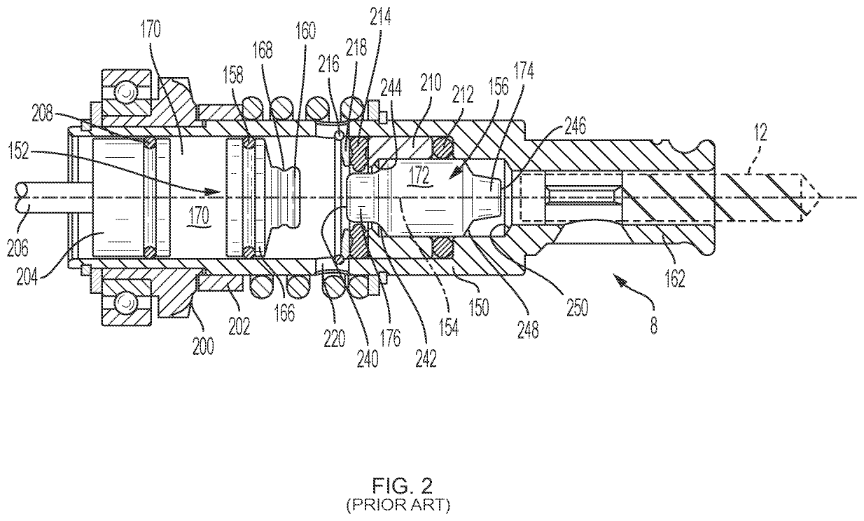

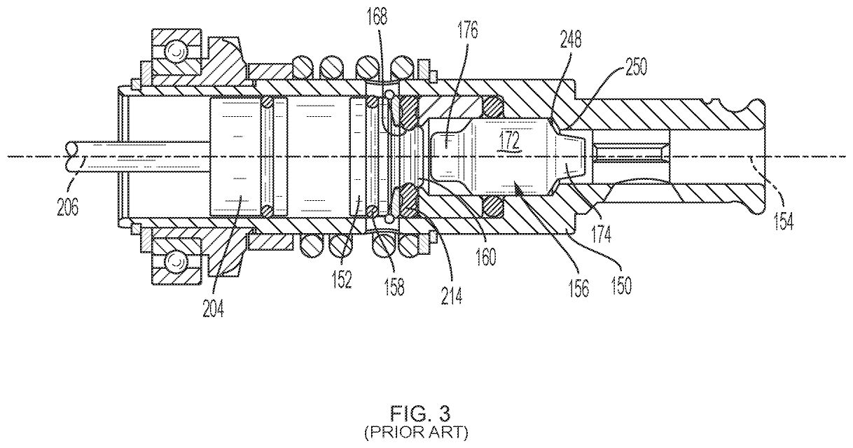

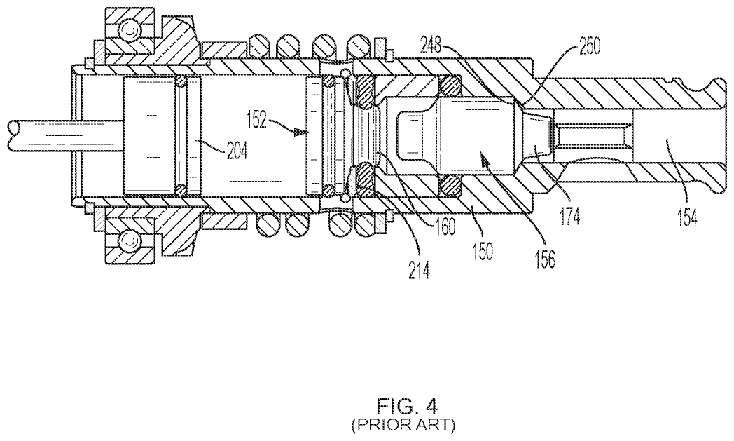

Corresponding reference numerals indicate corresponding parts throughout the several views of the drawings.

### DETAILED DESCRIPTION

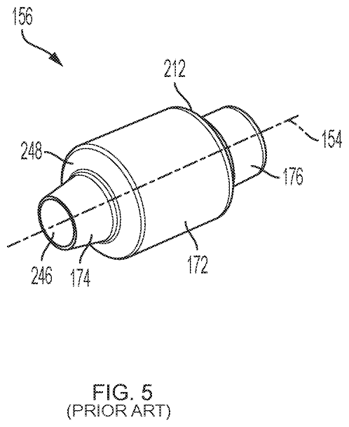

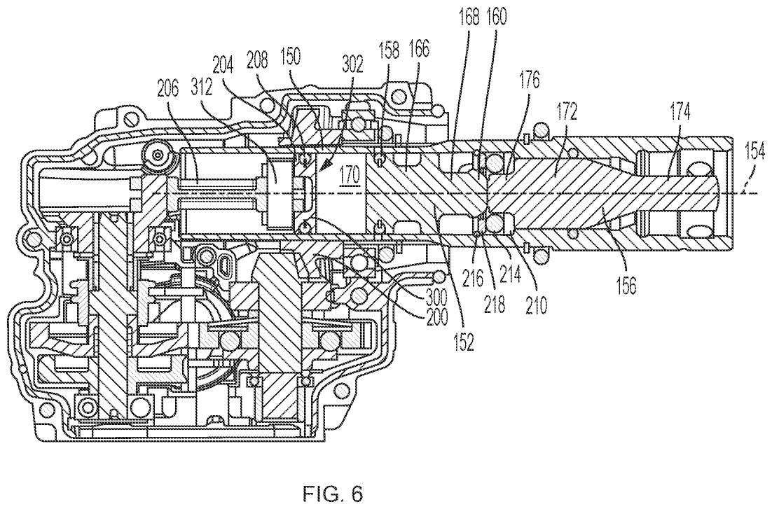

An embodiment of the present invention will now be described with reference to FIGS. 6 to 10.

FIG. 6 shows a cross section view of hammer drill having a piston 204 in accordance with the present invention. Where the same features in the embodiment shown in FIG. 6 are shown in the prior art example described above, the same reference numbers are used and the same description is applicable. The only difference between the prior art design and the embodiment is the design of the piston 204 and spindle 150.

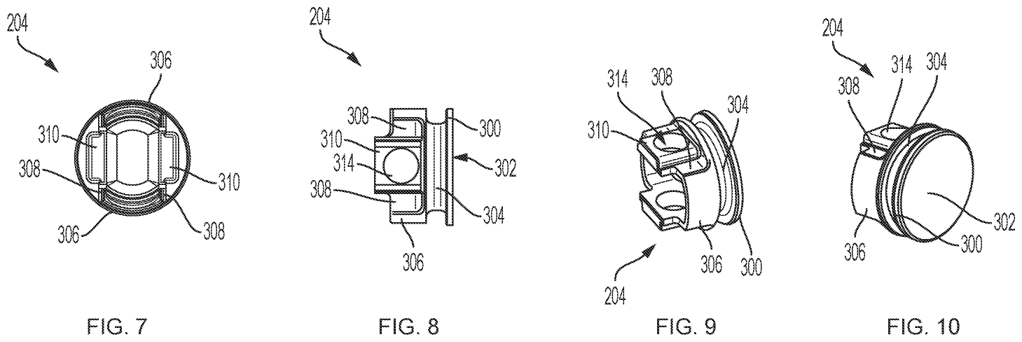

Referring to FIGS. 7 to 10, the piston 204 is a flat piston and comprises a front circular disk 300 having flat front surface 302. A circumferential groove 304 extends around the edge of the circular disk 300. A circular peripheral wall 306 extends rearwardly from the edge of the circular disk 300, perpendicularly to the plane of the circular disk 300. Two straight sections 308 are formed on two opposite sides of the wall 306. A frame 310 is formed on each straight section 308. An aperture 314 is formed through each frame 310 and straight section 308. The piston 204 is manufactured in a one-piece construction from sintered steel which has been impregnated with a lubricant such as oil.

The rubber O ring 208 locates in the groove 304. The piston 204 is mounted inside of the spindle 150 and connected to the crank shaft 206 via a cross pin 312.

The design of the spindle 150 is different from the prior art design described above in that it manufactured from steel. The coefficient of expansion of the steel spindle 150 is the same as that of the sintered flat piston 204.

Alternatively, the spindle 150 is manufactured from sintered steel. Ideally, it would be manufactured in a one-piece construction. The coefficient of expansion of the sintered steel spindle 150 is the same as that of the sintered flat piston 204. The sintered steel spindle 150 can impregnated with a lubricant such as oil.

The sintered steel piston 204 and/or sintered steel spindle 150 can be manufactured by using a sintering process and then submersing them in a lubricant to impregnate the piston and/or spindle with the lubricant.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A piston for a hammer drill, wherein the piston is a flat piston comprising sintered steel.

2. The piston of claim 1, wherein the piston is impregnated with a lubricant.

3. The piston of claim 2, wherein the lubricant is oil.

4. The piston of claim 1, wherein the piston comprises a front circular disk having a flat front surface, further comprising:
a circumferential groove extending around the edge of the circular disk;
a circular peripheral wall extending rearwardly from the edge of the circular disk perpendicularly to the plane of the circular disk;
two straight sections formed on two opposite sides of the circular peripheral wall;
two frames formed on the two straight sections; and
two apertures each formed through a corresponding one of the frames and straight sections.

5. A hammer drill comprising:
a housing;
a tool holder mounted on the housing capable of holding a cutting tool;
a motor mounted within the housing; and
a hammer mechanism comprising:
a cylinder;
a piston mounted in the cylinder and reciprocatingly driven along a longitudinal axis by the motor, wherein the piston is a flat piston comprising sintered steel;
a ram mounted in the cylinder forward of the piston and reciprocatingly driven along the longitudinal axis by the piston via an air spring; and
a beat piece supported in an axially slideable manner along the longitudinal axis within a beat piece support structure, wherein, during a normal operation of the hammer mechanism, the beat piece is repetitively struck by the ram and transfers impacts to a cutting tool held by the tool holder.

6. The hammer drill of claim 5, wherein the cylinder is made from steel.

7. The hammer drill of claim 5, wherein the cylinder is formed as a part of a spindle.

8. The hammer drill of claim 5, wherein the cylinder is made from sintered steel.

9. The hammer drill of claim 8, wherein the cylinder is impregnated with a lubricant.
